(19) United States
(12) Patent Application Publication
(10) Pub. No.: US 2010/0086649 A1
(43) Pub. Date: Apr. 8, 2010

(54) KNEADABLE AND MOULDABLE BAKING MIXTURE

(76) Inventor: Stefan Kaczmarek, Idstein (DE)

Correspondence Address: ROBERTS & ROBERTS, LLP;ATTORNEYS AT LAW, P.O. BOX 484, PRINCETON, NJ, 08542-0484, US

(21) Appl. No.: 12/443,073

(22) PCT Filed: Aug. 20, 2007
(86) PCT No.: PCT/EP07/58616

§ 371 Date: Mar. 26, 2009

(30) Foreign Application Priority Data
Sep. 28, 2006 (DE) 20 2006 016 009.9

(51) Int. Cl. A21D 10/02; A21D 8/02; A21D 4/00; A23L 1/302

(52) U.S. Cl. 426/72; 426/549; 426/558; 426/504

(57) ABSTRACT

The invention relates to a kneadable and mouldable baking mixture, wherein the sugar part corresponds to up to 32 wt. %, the flour part corresponds to between 10 and 50 wt. %, the starch part corresponds to between 0 and 20 wt. %, the water part corresponds to between 5 and 30 wt. %, the animal and/or vegetable protein part is equal to 1.5 wt. %, and the animal and/or vegetable fat part corresponds to between 0 and 5 wt. %.

The subject of the present invention is a kneadable and moldable making mixture which, for one, has a good kneading consistency in the raw state and, on the other hand, is dimensionally stable to the greatest extent during curing in the oven and tastes good afterwards.

A multitude of modeling materials is known, which contain wax and/or oil as binders (DE 202 00 796 U1 , DE 102 01 946 B4 and DE 20 2006 001 786 U1). Furthermore, a material for kneading is known, which consists of glycerin, tensides and dyes (DE 103 39 807 A1). However, all these compositions have the disadvantage that they are not suitable for eating.

Therefore the object of the present invention was to make available a baking mixture which, in the raw state, has a good kneading consistency and does not adhere to fingers or the supporting surface and, following curing, results in mechanically stable figures, and furthermore tastes good at each stage of use.

This object was attained by a kneading and baking mixture having a proportion of sweetener between 0 and 50% by weight, a proportion of flour between 10 to 50% by weight, a proportion of starch between 0 and 20% by weight, a proportion of water between 5 to 30% by weight, a proportion of animal and/or vegetable protein between 0 and 5% by weight, and a proportion of animal and/or vegetable fat between 0 and 5% by weight.

Such a baking mixture in accordance with the invention is distinguished by good kneading consistency and tastes good as well. The mixture in accordance with the invention does not adhere to fingers or the supporting surface but does, however, allow the adherence of independently shaped figure elements to each other, and can therefore be used as an edible modeling material by children in particular. In this connection it is of particular advantage that the baking mixture tastes good at any time during its use.

In connection with an advantageous embodiment of the baking mixture in accordance with the invention, it contains a proportion of sweetener of 32% by weight, a proportion of flour of 40% by weight, a proportion of starch of 8% by weight, a proportion of water of 16% by weight, a proportion of animal and/or vegetable protein of 1.5% by weight, and a proportion of animal and/or vegetable fat of 1.5% by weight.

It is particularly advantageous if the baking mixture of the invention contains sugar, preferably sugar refined from sugar cane or sugar beets, or sugar from starch, dextrose, vanilla sugar, powdered sugar, inverted sugar or hybrid sugar.

It is possible for the purpose of an advantageous embodiment to selectively use wheat flour, rye flour, spelt and/or soy flour for the baking mixture. Preferably, the starch can be gluten-free cornstarch, or potato starch, wheat starch or rice starch.

Furthermore, in an advantageous embodiment variation of the invention, it can contain dried chicken protein or milk powder as the animal protein, and dried chicken egg yolk as the animal fat. Such a dry baking mixture has a good shelf life and can be offered as a finished mix. For producing a ready-to-use kneadable and moldable baking mixture, the required proportion of water is added to the dry, powder-like ready mix. This means that it is only necessary to add tap water to the ready mix of sweetener, flower, starch, animal and/or vegetable protein, was well as animal and/or vegetable fat, in order to obtain the kneadable and moldable baking mixture. Such a ready mix can for example be offered in paper and/or cardboard packaging, or in plastic containers. It is also possible to offer the kneadable and moldable baking mixture in accordance with the invention ready for use, i.e. including the water proportion, in appropriate plastic containers, in which case preservatives are additionally required.

In a further advantageous embodiment of the invention, the respective proportion of animal protein, animal fat and the water portion of the ready-to-use baking mixture, which only contains sweetener, flour and starch, is alternatively achieved by adding the egg white and the egg yolk of a raw chicken egg. This ready mix, too, without the components of the egg, can for example be offered in cardboard packaging or in plastic containers.

Furthermore, the ready-to-use baking mixture can contain vegetable oil, or for example peanut butter, as the vegetable fat.

It is furthermore possible to add portions of honey to the baking mixture. Additional proportions of nutrients and/or nutritious additives are contained in an advantageous embodiment variation of the baking mixture. For this purpose it is possible to add calcium, various vitamins and/or trace elements in particular. It can furthermore be of advantage to add aromatic substances, such as vanilla, lemon or cinnamon, for example, or to knead in chocolate.

The baking mixture in accordance with the invention is also distinguished in that it well absorbs food coloring. It is thus possible to achieve the desired coloration by the addition of appropriate proportions of food coloring, while the baking mixture in accordance with the invention assures only slight discoloration during curing in the oven.

Because of the low proportion of fat, the baking mixture in accordance with the invention avoids large stains on the supporting surface in the course of kneading. The baking mixture in accordance with the invention has the advantage that figures, in particular those kneaded by children, are dimensionally stable to the greatest extent during baking, and the finished baked goods taste good.

Following a first kneading process, the ready-to-use baking mix is stored for a few hours in a refrigerator at 4 to 8° C. and can subsequently be shaped in the form of edible modeling material into appropriate figures. After the ripening process in the refrigerator, it is possible to again add a little cornstarch for improving kneadability. Curing of the shaped figures takes place by means of a baking process of 15 to 30 minutes, preferably 25 minutes, at 100 to 150° C., preferably 120° C.

Use of the edible modeling material in play has a particular educational value, since modeling prompts creativity. Starting in the second year of life, it is important for children to gain sensor capabilities by touching, shaping and dividing. In the process, kneading also aids the motor functions. In older children, recognition, imagination and creativity are more encouraged. In this connection the use of strong colors is matched to the needs of the children in particular.

Modeling material is successfully employed in the therapy of children suffering from speech defects or motor defects. Modeling material is furthermore also employed in adult therapy, such as for example in case of hand or wrist operations, or in case of rheumatic troubles.

The edible modeling material can also be employed in connection with therapeutic baking. Here, the edible molding material is used in the course of kneading, as well as baking.

For understanding the invention further, an exemplary embodiment will be described in what follows.

### EXAMPLE

200 g powdered sugar, 250 g wheat flour, two table spoons of cornstarch and two medium-sized chicken eggs are mixed together and kneaded for 15 minutes. After a ripening time of 12 hours in a refrigerator at 4° C., the baking mixture is again kneaded by hand for 15 minutes, in the course of which a little cornstarch was again added. After molding the desired figures, baking takes place at 120° C. for 25 minutes.

1. An edible modeling material comprising:
a proportion of sweetener of up to 50% by weight,
a proportion of flour of 10 to 50% by weight,
a proportion of starch of 0 to 20% by weight,
a proportion of water of 5 to 30% by weight,
a proportion of animal and/or vegetable protein of between 0 and 5% by weight, and
a proportion of animal and/or vegetable fat of 0 to 5% by weight.

2. The edible modeling material in accordance with claim 1, wherein the sweetener comprises refined sugar from sugar cane or sugar beets, or sugar from starch, dextrose, vanilla sugar, powdered sugar, inverted sugar or hybrid sugar.

3. The edible modeling material in accordance with claim 1 wherein the flour comprises wheat flour, rye flour, spelt and/or soy flour.

4. The edible modeling material in accordance with claim 3, wherein the flour is present in a proportion of 40% by weight.

5. The edible modeling material in accordance with claim 1 wherein the starch comprises potato starch, wheat starch, rice starch, or corn starch.

6. The edible modeling material in accordance with claim 5, wherein the starch is present in a proportion of 8% by weight.

7. The edible modeling material in accordance with claim 1 wherein the water is present in a proportion of 16% by weight.

8. The edible modeling material in accordance with claim 1 wherein the protein comprises dried chicken protein or milk powder.

9. The edible modeling material in accordance with claim 1 wherein the animal fat comprises dried chicken egg yolk.

10. The edible modeling material in accordance with claim 1 wherein the animal protein, animal fat and the water are from an egg yolk from a raw chicken egg.

11. The edible modeling material in accordance with claim 1 wherein the fat comprises peanut butter or a vegetable oil.

12. The edible modeling material in accordance with claim 11, wherein the fat is present in a proportion of 1.5% by weight.

13. The edible modeling material in accordance with claim 1 which comprises honey.

14. The edible modeling material in accordance with claim 1 which further comprises at least one of calcium, vitamins and/or nutrients.

15. The edible modeling material in accordance with claim 1 which further comprises at least one of aromatic substances, vanilla, lemon, cinnamon, or chocolate.

16. The edible modeling material in accordance with claim 1 which further comprises a food dye.

17. A method for producing formed figures comprising:
providing the edible modeling material of claim 1;
kneading the edible modeling material;
storing the edible modeling material at 4 to 8 ° C.;
subsequent forming the edible modeling material into a figure;
baking the formed figure at 100 ° C. to 150 ° C. for from 15 to 30 minutes to harden the figure.

18. The method as claimed in claim 17, wherein the baking is conducted at 120 ° C. for 25 minutes.

19. The edible modeling material of claim 1 comprising:
a proportion of sugar of up to 32% by weight,
a proportion of flour of 10 to 50% by weight,
a proportion of starch of 0 to 20% by weight,
a proportion of water of 5 to 30% by weight,
a proportion of animal and/or vegetable protein of 1.5% by weight, and
a proportion of animal and/or vegetable fat of 0 to 5% by weight.
